(19) United States
(12) Patent Application Publication
(10) Pub. No.: US 2020/0256756 A1
(43) Pub. Date: Aug. 13, 2020

(54) METHOD AND SYSTEM FOR DETECTING A LEAK IN A FLUID SYSTEM

(71) Applicant: Robert Bosch GmbH, Stuttgart (DE)

(72) Inventor: Johannes Schild, Abstatt (DE)

(21) Appl. No.: 16/758,884

(22) PCT Filed: Oct. 10, 2018
(86) PCT No.: PCT/EP2018/077586

§ 371 Date: Apr. 24, 2020

(30) Foreign Application Priority Data
Oct. 25, 2017 (DE) 10 2017 219 055.8

(51) Int. Cl. G01M 3/26; H01M 8/0438; H01M 8/04537; H01M 8/04664

(52) U.S. Cl. CPC G01M 3/26; H01M 8/04402; H01M 2250/20; H01M 8/04589; H01M 8/04679; H01M 8/0441

(57) ABSTRACT

The invention relates to a method for detecting a leak in a fluid system, in particular a fuel cell system, comprising the steps of determining an outflow amount of at least one first fluid (2) within a certain time interval, determining an expected consumption of the first fluid (2) during the certain time interval, determining a difference between the determined outflow amount and the determined expected consumption, and detecting a leak on the basis of a comparison between a reference value and the determined difference.

### BACKGROUND

Methods and systems for detecting a leak in fluid systems are known from the prior art. For this purpose, pressure sensors, which can monitor the system pressure in suitable operating states and can detect leaks in both a stationary state and a non-stationary state, are usually arranged in different areas of a fluid system. In a stationary state in which no gas is flowing, a leak is usually registered by means of a rapid pressure drop. On the other hand, during the ongoing operation of a fluid system, with an existing gas flow, a leak can only be detected by registering that an excessively low pressure occurs in a flow equilibrium.

### SUMMARY

Here, features and details described in connection with the method according to the invention, of course also apply in connection with the system according to the invention and the fuel cell system according to the invention and vice versa in each case, so that this is or can always be referred to reciprocally regarding the disclosure for the individual aspects of the invention.

The method is used in particular for detecting a leak in a fluid system, preferably a fuel cell system, in particular a PEM fuel cell system. The advantage of the method is to be seen above all in the fact that even during the ongoing operation of a fluid system, even smaller leaks can be reliably detected. This is not possible with conventional methods of detecting a leak. Here, only medium to large leaks can be reliably detected in an active state. High system leak tightness is a safety-relevant factor, especially in a PEM fuel cell system, since hydrogen is a highly flammable gas and is usually present in larger quantities in PEM fuel cells.

The method according to the invention for detecting a leak of a fluid system can preferably be used in a vehicle, in particular a fuel cell vehicle. With the method according to the invention, an outflow rate at least of a first fluid within a certain time interval is first determined. The determination of the outflow rate of the first fluid can be done directly or indirectly. In a direct determination, for example, a fluid flow can be determined by means of a level indicator or a flowmeter. According to an indirect method, an outflow rate can also be determined indirectly from various other, preferably measured parameters. The time interval can preferably be freely selected. Advantageously, at the same time as the determination of the outflow rate of the first fluid, an expected consumption of the first fluid is determined. As an alternative to a contemporaneous determination, the expected consumption can also be determined before or after the determination of the outflow rate of the first fluid.

For the most meaningful comparison between the determined outflow rate and the determined expected consumption, the time intervals between the determinations should preferably be as close as possible to each other, preferably equal. Furthermore, for the most meaningful comparison between the determined outflow rates or the calculated expected consumption, it is necessary that the time intervals are essentially the same. Alternatively, however, it is also possible that one of the two determined variables is determined in a shorter time interval, provided that a suitable extrapolation to the longer time interval is carried out.

After determining an outflow rate of a first fluid and determining an expected consumption of the first fluid, the difference of the determined outflow rate and the determined expected consumption of the first fluid can be determined. Here, the difference can be formed directly from individual values or, only after a certain number of values have been determined, on the basis of the then averaged values. Following the determination of the difference, a leak is subsequently detected, which is determined on the basis of a comparison between a reference value and the determined difference. A reference value is preferably a constant system-dependent value, which can take into account any measurement inaccuracies. Thus, in the idealized case, a reference value can be 0 if it is assumed that a system is completely sealed and that there are no measurement inaccuracies. Thus, in this case, no difference between an outflow rate and an expected consumption of a first fluid can be recorded.

However, since no system is completely sealed and some measurement inaccuracies are unavoidable, this can already be taken into account using a constant reference value. In the meantime, a comparison between the reference value and the determined difference can be carried out in various ways. In the simplest case, the comparison will be carried out based on the mere difference between the reference value and the determined difference, wherein in particular a leak is detected in the event of a deviation from the reference value by at least a specified limit value. In the context of a particularly flexible detection method, which is applicable to different systems and takes into account individual environmental conditions, tolerance factors or tolerance ranges can also be included in the detection process. When using a tolerance factor, a leak can only be detected if the product of the deviation and the tolerance factor exceeds the limit value for example, so that the tolerance factors can be determined according to the external conditions and the system conditions. Alternatively, when using a tolerance range, a leak can only be detected if the sum of the deviation and the tolerance range exceeds the limit value, for example. In order to ensure a continuous check for leaks, it may also be advantageously provided that steps 1 to 4 of the present method are repeated cyclically. In order to improve the validity of the method and possibly to increase the accuracy of the method, it may also be provided that only individual steps of the method are repeated multiple times before the corresponding subsequent step is initiated.

Advantageously, in the context of the invention it may be provided that the determination of an outflow rate of at least a first fluid is carried out at least partially on the basis of a pressure and/or temperature measurement of the first fluid. An outflow rate determination based on pressure and/or temperature measurements promises not only a simple and flexible way, but also an exact way of determining an outflow rate of a fluid. Especially in the case of slightly volatile gases, a volume determination, for example by means of level indicators, floats or flow meters, is often erroneous, because, depending on the composition of the fluid, the density of the fluid within the container varies and thus a volume determination can be distorted. By means of a pressure and/or temperature measurement, on the other hand, a fluid volume can be determined for example at two different times and an outflow rate can be determined by means of the difference of the fluid volumes at the different times. For example, in a PEM fuel cell, the outflow rate of hydrogen can be determined by means of the difference volume. The volume of hydrogen can be composed as follows:

V(H₂)=p/p₀*T/T₀*Vₒ

Here P₀ and T₀ denote the atmospheric pressure (1,013*10⁶ Pa) and the room temperature (298.15 K) and V₀ denotes the net volume of the tank. The volume of the hydrogen that flowed out results from the volume difference of the hydrogen at the two different times (converted to standard conditions), from which the amount of material or the mass of the leaked hydrogen can ultimately be calculated.

With regard to the determination of the expected consumption of the first fluid, it may also be provided in the context of the invention that the determination is carried out at least partially on the basis of the generated current and/or on the basis of the detected outflow rate from the drain or vent valve and/or on the basis of a characteristic variable for the fluid system. A particularly simple determination results in particular from calculating the expected consumption of the first fluid from the measured current or the charge that has flowed. Here, the consumption of the fluid results according to the stoichiometry of the reaction. In a PEM fuel cell, for example, 2 coulombs of a measured charge corresponds to an amount of material of 1 mol of hydrogen. The quantity of the substance can be converted accordingly into the volume or the mass of the corresponding fluid.

In addition to a determination based on the measured current or the charge that has flowed, an additional inclusion of the outflow rate from the drain or discharge valve can be used for a particularly precise determination of the expected consumption of the first fluid and for the prevention of false alarms. For example, if insufficient oxygen is currently added to the other side of the fuel cell, it may happen that some of the hydrogen is not reacted to at all during the reaction. In this case, the expected consumption of hydrogen, determined exclusively from the measured current or the charge that has flowed, would be significantly lower than the actual hydrogen outflow, so that without correction by the additional inclusion of the outflow rate from the drain or vent valve a leak would be detected despite the complete leak tightness of the system and thus a false alarm would be triggered. The gas outflow from the drain or vent valve can be determined either from the valve properties, temperature and differential pressure, or without opening the drain or vent valve.

In order to further optimize the present method, in the context of a particularly exact execution of the method according to the invention which is flexibly adaptable to different systems at the same time, it can be provided that the determination of the expected consumption of the first fluid is at least partly based on a characteristic variable of the fluid system. Here, the characteristic variable of the fluid system can be constant or can also be determined or measured continuously or cyclically. The inclusion of characteristic variables of the fluid system, in particular in combination with the determination of the expected consumption of a first fluid based on the measured current or the charge that has flowed, and the inclusion of the outflow rate from the drain or vent valve can be useful in order to include system-specific or fluid-specific or environmental condition-specific variables in the determination. For example, the characteristic variables for the fluid system in the context of a system-specific variable can be related to the stack model (of the fuel cells) or to the individual stack and, for example, can relate to a degree of implementation of the system. In the context of a fluid-specific variable, the characteristic variables may be related, for example, to the density or the volatility, combustibility, flammability or toxicity of the fluid. In the context of an environmental condition-specific variable, the characteristic variable can be related to the outside temperature, the external pressure or the like, for example.

In order to also ensure the most economical operation in addition to the greatest possible system leak tightness, it is also provided according to the invention that the method can be carried out in a reliable manner even during ongoing operation. Reliable leak detection during ongoing operation is desirable due to the safety relevance, especially during the use of hazardous substances, such as easily flammable, easily combustible, easily ignited fluids or fluids that are hazardous to health. As an alternative to reliable leak detection during ongoing operation, only a test in the stationary state would otherwise remain. However, being able to carry out a reliable test for a leak only in the stationary state would severely restrict the operation of a fluid system, since in the case of a desired periodic monitoring for possible leaks, the operation of a fluid system would be severely limited, since the operation would need to be interrupted at regular intervals to perform a reliable leak test. In the context of the invention, the detection of smaller leaks of less than 100 standard ml per connection point and per hour, preferably less than 50 standard ml per connection point and per hour, in particular less than 20 standard ml per connection point and per hour, would be viewed as a reliable method.

Furthermore, it is conceivable in particular for further optimization of the reliability of the method according to the invention that the method for detecting a leak uses at least one parameter of at least a second fluid, in particular the outflow rate and/or the expected consumption of the second fluid, in addition to the outflow rate and the expected consumption of the first fluid. The inclusion of a parameter of a second fluid is particularly useful if the present method for detecting a leak of a fluid system does not include a determination of the outflow rate from the drain or vent valve. Thus, for example, by knowing the rate of use of a second fluid and by knowing the stoichiometry of the reaction, it can be determined whether stoichiometrically equal substance quantity ratios of the reaction partners were used, whereby the expected consumption of a first fluid can be corrected accordingly in the case of an unequal substance quantity ratio of the reaction partners. Furthermore, according to the invention, it may be provided that other parameters, such as the water content of the membrane and/or the water content of the discharge system and/or the water content of the gas distribution structure and/or the ambient temperature and/or the ambient pressure or the like are also used in addition to the determination of the outflow rate and the expected consumption of the first fluid as well as at least one parameter of a second fluid for further optimization of the validity of a leak detection.

Advantageously, in the context of the invention, it may also be provided that an error is indicated and/or an error correction measure is initiated on the basis of the comparison, preferably on the basis of the difference between a reference value and the determined difference between the outflow rate and the expected consumption, in particular if at least one limit value is exceeded. Here an error correction measure can mean in particular an at least partial shutdown, in particular complete shutdown of the fluid system. As an alternative to a partial or complete system shutdown, if a limit value is exceeded it may also be provided in the context of a pure error indication that a warning message is first given with the error indication, with which a further, in particular more accurate test for detecting a leak is initiated.

Basically, the method according to the invention can be applied on the medium pressure side or the high pressure side of a fuel cell system (medium pressure approx. 9 to 13 bar/high pressure approx. 350 to 700 bar), wherein here even the slightest leak can be detected immediately by this method.

The subject matter of the invention is also a system for detecting a leak in a fluid system, in particular a fuel cell system. In this case, it is provided that the system comprises at least one sensor unit for the detection of variables for determining an outflow rate of at least a first fluid. In addition, the system according to the invention has a control unit for determining an expected consumption of the first fluid and for determining a difference between the determined outflow rate and the determined expected consumption. Furthermore, the present system comprises at least one detection unit for detecting a leak on the basis of a comparison between a reference value and the determined difference. Thus, the system according to the invention brings with it the same advantages as described in detail with reference to the method according to the invention. As has already been explained in the explanations of the method according to the invention, the present system is preferably provided for detecting a leak of a fluid system, in particular of a fuel cell system. The advantage of the system according to the invention lies in particular in that reliable detection of even small leaks can be carried out by means thereof, including during an active state of a fluid system. To control the system according to the invention, the individual system components are preferably connected to each other via control or communication connections. The control or communication connections can be formed at least partially wirelessly and/or at least partially wired. Advantageously, the control and/or communication connections can be connected to each other via a bus system, in particular a CAN-BUS system.

Furthermore, in the context of this invention it is proposed that the system has an error display unit or an error correction unit for displaying or correcting errors, wherein the error display unit or error correction unit is preferably activated on exceeding a limit value concerning the difference between a reference value and the determined difference between the outflow rate and the expected consumption. Vibrational and/or acoustic and/or visual elements may be provided as error display elements. For example, an error display may include all or even only individual elements. Similarly, the display elements can also be determined by the size of the deviation. Thus, in the case of a small deviation, only a vibrational error indication may be given. In the event of a larger deviation, either only an audible error indication may be given or a vibrational and an audible error indication. In the event of an even larger deviation, only a visual or audible, vibrational and visual error indication may be given. Thus, an operator of a fluid system can be informed very early about a detected leak and also the size of the leak. In the present case an emergency switch-off element for an at least partial, preferably complete shutdown of the fluid system may be provided as an error correction unit.

An object of the invention is also a fuel cell system, in particular a (fuel cell) vehicle, comprising the system according to the invention for the execution of the method according to the invention.

### BRIEF DESCRIPTION OF THE DRAWINGS

Further advantages, features and details of the invention arise from the following description, in which exemplary embodiments of the invention are described in detail with reference to the drawings. Here the features mentioned in the claims and in the description may each be essential to the invention individually in themselves or in any combination.

In the figures:

FIG. 1 shows a schematic representation of a system according to the invention for detecting a leak of a fluid system;

FIG. 2 shows a schematic representation of a method according to the invention for detecting a leak of a fluid system.

In the figures, identical reference characters are used for the same technical features.

### DETAILED DESCRIPTION

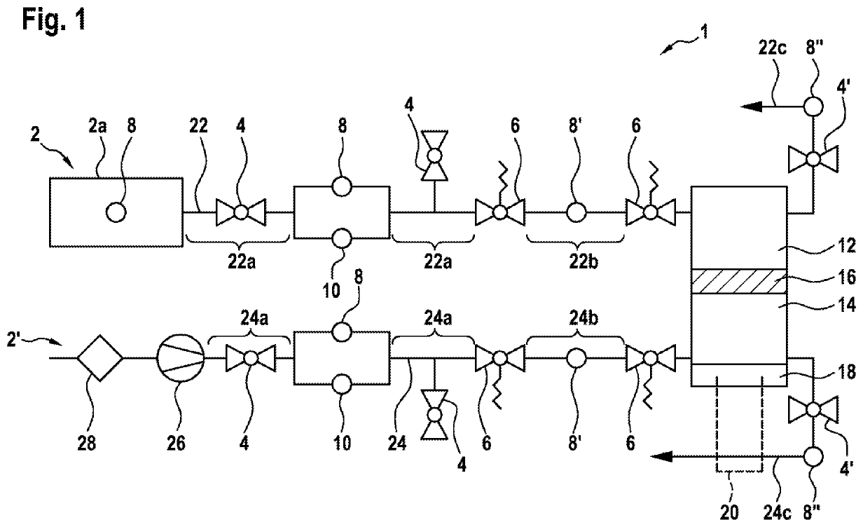

FIG. 1 shows a schematic representation of a system according to the invention 1 for detecting a leak of a fluid system. The system 1 comprises a fuel cell comprising an anode 12 and a cathode 14, which are separated from each other by the membrane 16. For cooling the fuel cell, a cooling unit 18 comprising a cooling circuit 20 is arranged on the cathode 14 side of the fuel cell. Both the anode 12 and the cathode 14 are electrically connected to the membrane 16. The anode gas 2, which is hydrogen in the present case, flows around the anode 12 of the fuel cell during operation. The hydrogen 2 is arranged in the container 2a, which has a pressure sensor 8 for measuring the current container pressure. By opening the shut-off valve 4, the hydrogen gas 2 is first fed into the high pressure region 22a of the anode gas line 22. Here, a pressure and temperature measurement of the discharged gas 2 first takes place by means of the arranged pressure 8 and temperature sensors 10, from which the amount of hydrogen 2 discharged is finally determined. By regulated opening of the dosing valve 6, the anode gas 2 flows through the medium pressure region 22b of the anode gas line 22 arranged downstream of the dosing valve 6 and in which another pressure sensor 8′ designed for medium pressure ranges is arranged for measurement of the current hydrogen pressure. The gas finally reaches the anode 12 via another dosing valve 6.

On the opposite side from the anode gas 2, the cathode gas 2′ is introduced, in the present case oxygenated fresh air. The air 2′ is sucked in and first filtered in the air filter 28. The air filtration is used to protect fuel cell components from harmful particles and gaseous impurities from the air sucked in. After filtration, the cathode gas 2′ is compressed by means of the compressor 26 and fed via the shut-off valve 4 into the high pressure region 24a of the cathode gas line 24, in which—just as in the anode gas line 22—a pressure and temperature measurement is also carried out by means of the arranged pressure 8 and temperature sensors 10. From the determined pressure and temperature values, the discharged amount of cathode gas 2′ can also be determined analogously to the determination of the discharged amount of anode gas 2. Subsequently, the cathode gas 2′ is fed via the dosing valve 6 into the medium pressure region 24b of the cathode gas line 24, in which another pressure sensor 8′ designed for medium pressure ranges is arranged for pressure measurement of the current cathode gas pressure. The cathode gas 2′ is finally fed to the cathode 14 via a further dosing valve 6. Discharge lines 22c and 24c are arranged both on the anode 12 side and on the cathode 14 side, in which the pressure can be determined by means of the pressure sensors 8″ and via which the unused residual gases and reaction products can be discharged (in a controlled way), in particular via provided shut-off valves 4′. The anode gas 2 not consumed in the reaction is preferably fed back to the system via a corresponding line.

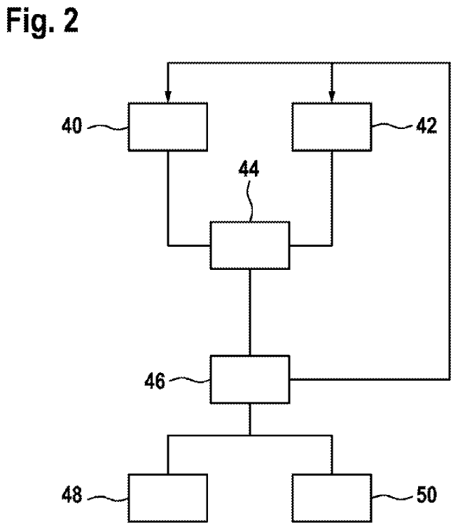

FIG. 2 shows a schematic representation of a method according to the invention for detecting a leak of a fluid system 1 comprising the steps 40 through 50. In steps 40 and 42, a flow rate of at least a first fluid 2 and an expected consumption of the first fluid 2 are preferably determined simultaneously within a certain time interval. As an alternative to a contemporaneous determination, the expected consumption can also be determined before or after the determination of the outflow rate of the first fluid 2, however for the most meaningful comparison possible between the amount of outflow determined and the expected consumption, the intervals between the determinations should be as close to each other as possible, so that the same conditions prevail for both determinations as far as possible. Furthermore, for the most meaningful comparison between the determined discharge amount and the determined expected consumption, it is necessary that the time intervals are essentially of the same length. Alternatively, however, it is also possible that one of the two determined variables is determined in a shorter time interval, provided that a corresponding extrapolation to the longer time interval is then carried out.

After the determination of the outflow rate and the expected consumption of a first fluid 2, the difference between the two variables is determined in step 44. In this case, the difference can be determined directly from individual values or only after a certain number of values have been determined, based on the then averaged values.

Finally, in step 46, a comparison is made between a reference value and the determined difference between the outflow rate and the expected consumption of the first fluid 2, based on which a leak can be identified. A reference value is preferably a constant system-dependent value, which can take into account any measurement inaccuracies. Thus, in the idealized case, a reference value can be O if it is assumed that a system is completely sealed and that there are no measurement inaccuracies. Thus, in this case, no difference between an outflow rate and an expected consumption of a first fluid can be registered. However, since no system is completely sealed and some measurement inaccuracies are unavoidable, this can already be taken into account by means of a constant reference value. The reference value and the determined difference can be compared in various ways. In the simplest case, the comparison is based on the mere difference between the reference value and the determined difference, wherein a leak is detected in particular in the event of a deviation from the reference value by a certain limit value. In the context of a particularly flexible detection process that is applicable to different systems and that takes in to account individual environmental conditions, tolerance factors or tolerance ranges can also be included in the detection process. If a deviation that exceeds a certain limit value is determined during the comparison between the reference value and the determined difference between the outflow rate and the expected consumption, an error is indicated and/or an error correction measure is initiated in steps 48 and 50 respectively. If a deviation does not exceed a certain limit value, steps 40 through 46 will be carried out again. In order to ensure continuous leak checking, it is particularly advantageous if steps 40 through 46 of the present method are repeated cyclically, as long as a deviation between a reference value and the determined difference between the outflow rate and the expected consumption does not exceed a limit value.

1. A method for detecting a leak in a fluid system, the method comprising:
Determining an outflow rate of at least one first fluid (2) within a certain time interval;
Determining an expected consumption of the first fluid (2) during the specified time interval;
Determining a difference between the determined outflow rate and the determined expected consumption;
Detecting a leak on the basis of a comparison between a reference value and the determined difference.

2. The method as claimed in claim 1, characterized in that the determination of an outflow rate of at least one first fluid (2) is carried out at least partially based on a pressure and/or temperature measurement of the first fluid (2).

3. The method as claimed in claim 1, characterized in that the determination of the expected consumption of the first fluid (2) is carried out at least partly on the basis of the generated current and/or on the basis of the recorded outflow rate from a drain or vent valve (4′) and/or on the basis of a characteristic variable of the fluid system.

4. The method as claimed in claim 1, characterized in that the method is used in a fluid system in a vehicle.

5. The method as claimed in claim 1, characterized in that the method is used during the operation of the fluid system.

6. The method as claimed in claim 1, characterized in that the method for detecting a leak, in addition to the outflow rate and the expected consumption of the first fluid (2), uses at least one parameter of at least one second fluid (2′).

7. The method as claimed in claim 1, characterized in that an error is indicated and/or an error correction measure is initiated on the basis of the comparison.

8. A system for detecting a leak in a fluid system, the system comprising:
at least one sensor unit for detecting variables for determining an outflow rate of at least a first fluid (2) within a certain time interval;
at least one control unit for determining an expected consumption of the first fluid (2) during the specified time interval and for determining a difference between the determined outflow rate and the determined expected consumption;
at least one detection unit for detecting a leak on the basis of a comparison between a reference value and the determined difference.

9. A system as claimed in claim 8, characterized in that the system has an error display unit or an error correction unit for indicating or correcting errors, wherein the error display unit or error correction unit is activated when a limit value concerning the difference between a reference value and the determined difference between the outflow rate and the expected consumption is exceeded.

10. The system of claim 8, wherein the system is a fuel cell system of a vehicle.

11. The method of claim 1, characterized in that the fluid system is a fuel cell system.

12. The method of claim 4, characterized in that the method is used in a fluid system in a fuel cell vehicle.

13. The method as claimed in claim 6, characterized in that the at least one parameter of at least one second fluid (2′) is the outflow rate and/or the expected consumption of the second fluid (2′).

14. The method as claimed in claim 7, characterized in that the error is indicated and/or the error correction measure is initiated on the basis of a difference between a reference value and the determined difference between the outflow rate and the expected consumption.

15. The method as claimed in claim 15, characterized in that the error is indicated and/or the error correction measure is initiated when a limit value of the difference between the reference value and the determined difference between the outflow rate and the expected consumption is exceeded.
